(19) United States
(12) Patent Application Publication
(10) Pub. No.: US 2021/0405506 A1
(43) Pub. Date: Dec. 30, 2021

(54) Multiple Stop Orientation Follow Focus

(71) Applicant: Jeffrey Overall, Costa Mesa, CA (US)

(72) Inventor: Kyle Olinger, Laguna Beach, CA (US)

(73) Assignee: Polar Pro Filter, Inc., Costa Mesa, CA (US)

(21) Appl. No.: 17/469,065

(22) Filed: Sep. 8, 2021

(51) Int. Cl. G03B 13/18; H04N 5/232; G03B 3/10; G03B 13/32

(52) U.S. Cl. CPC G03B 13/18; H04N 5/23212; G03B 2205/0053; G03B 13/32; G03B 3/10

(57) ABSTRACT

A follow focus enabling a user to move quickly move into and out of a hard stop operation. A soft stop orientation provides haptic feedback at manually calibrated focusing settings.

### FIELD OF INVENTION

The present invention relates to devices aiding in the manual operation of a camera lens. Specifically, it relates to a follow focus providing haptic feedback when manually focusing.

### BACKGROUND

A follow focus is an auxiliary device used to improve the ability to manually change the focus of camera or camera lens. Traditionally, a follow focus is attached to shoulder brace, or other camera stabilizing or camera mounting device, or on the camera itself.

Existing iterations of follow focus include a wheel or knob. The knob is placed in a position where a camera operator can conveniently access and rotate it. Another component of the follow focus, herein referred to as a focus wheel, engages and rotates a camera lens. The camera operator rotates the knob, which rotates the focus wheel, which in turn rotates the camera lens.

It may be desirable to limit the rotation range of the follow focus. For example, a scene may require a camera operator to zoom from a first object to a second object relatively further from the camera. Prior art has remedied this problem by providing adjustable hard stops on the follow focus. Two hard stops enable the operator to set the limits of the focus range. In the above example, the one hard stop would be calibrated to focus the lens on the first object at one end of the rotation range; the second hard stop would be set to focus on the second hard stop at the other limit of the focus range. The rotation range is calibrated with so that the operator cannot rotate the knob past the point at which the desired object or scenery is in focus.

While this method simplifies the task of pulling focus between two objects, it prevents a camera operator from focusing on objects and surfaces outside of the focus range. If the hard stop calibration proves incorrect, or the object unexpectedly moves out of the focus range, the operator is prevented from focusing on that object. This can be solved by disengaging the stops and allowing the knob to spin freely. But this leaves the operator without any haptic guidance and makes it difficult to pull focus accurately and consistently.

What is needed is a device that provides haptic feedback alerting the operator when the limit of the focus range has been reached, while also allowing the operator to rotate the knob out of the focus range. The current invention, and its soft stop orientation, provides this solution.

### SUMMARY

The present invention enables the operator to quickly adjust the hard stop configuration of a follow focus and provides a soft stop orientation allowing an operator to rotate out of the set focus range, and provides haptic feedback when such rotation occurs.

A knob and a focus wheel are operatively coupled so that rotation of one causes the proportionate rotation of the other. “Operatively couple” may be used herein to describe the connection between multiple components which may be capable of moving in conjunction but are also capable of moving separate from each other. The knob is configured to be manually rotated. Two hard stop locks extend from the knob. Each hard stop lock couples with an inner lock. The hard stop locks may be adjusted around a rotation axis. The inner locks form a focus range, which in certain knob orientations limits rotation of the knob. When the desired focus range is reached, the hard stop locks are locked into the wheel housing, whereby they are held stable against rotation of the knob.

Two release buttons couple with a bumper. The bumper may extend from a lock ring; the lock ring may serve as the means of coupling the release buttons with the bumper. The release buttons also couple with a guide or guides. Each guide may comprise a tooth. A biasing device, such as a spring, may urge the release buttons—and, in turn, the guides outward, towards the sidewall of the knob.

The release buttons may be moved laterally towards or away from the hard stops. An inner surface of the knob may comprise one or more grooves. When the guide tooth, or teeth, is aligned with a groove, the biasing device may urge the tooth into the groove, whereby a stop orientation is created. Exertion of manual force on the release buttons may disengage the tooth from the groove, and enable movement of the teeth between stop orientations.

The knob may be capable of a plurality of stop orientations. In a hard stop orientation, the tooth or teeth may be engaged with a hard stop groove. In a hard stop orientation, the bumper may be oriented so that bumper cannot move past either inner stop. This prevents the operator from rotating the knob out of the set focus range.

A soft stop orientation may comprise another stop orientation. The tooth or teeth may be engaged with a soft stop groove. In a hard stop position, the bumper may be oriented to contact each inner stop when rotated to into alignment with it. But unlike the hard stop position, the soft stop orientation enables the operator to rotate the bumper out of and back into the focus range. The contact of the bumper and inner stop may provide haptic feedback to enable the operator to determine when the follow focus is being rotated into and out of the focus range.

Some embodiments may contain a free spin orientation, in which the bumper is situated to not contact either inner stop when it rotates past them. A free spin groove may engage the tooth, to lock the knob in a free spin orientation.

### BRIEF DESCRIPTION OF THE DRAWINGS

FIG. 1 is a front, top, and right perspective view of a follow focus.

FIG. 2 is a top exploded view of a follow focus.

FIG. 3 is a front, top, and right perspective view of a follow focus.

FIG. 4A is a top view of a follow focus.

FIG. 4B is a section view of the follow focus in FIG. 4A.

FIG. 5A is a top view of a follow focus.

FIG. 5B is a section view of the follow focus in FIG. 5A.

FIG. 6A is a front view of a follow focus.

FIG. 6B is a section view of the follow focus in FIG. 6A, showing a follow focus in a the hard stop orientation.

FIG. 7 is a back, top, right perspective view of a follow focus with the clip removed and a larger stop range than the follow focus in FIG. 1.

FIG. 8 is a top view of a follow focus of with the knob and knob ring removed to show the stops in a hard stop orientation.

FIG. 9 is a top view of a follow focus of with the knob and knob ring removed to show the stops in a soft stop orientation.

FIG. 10 is a top view of a follow focus of with the knob and knob ring removed to show the stops in a free spin orientation.

FIG. 11 is a top view of a follow focus of with the knob and knob ring removed to show the stops in a hard stop orientation with the stops engaging the bumper.

FIG. 12 is a top view of a follow focus of with the knob and knob ring removed to show the stops in a soft stop orientation with the stops engaging the bumper.

FIG. 13 is a front view of a follow focus with the stop locks in a relatively narrow orientation.

FIG. 14 is a is a front view of a follow focus with the stop locks in a relatively wide orientation.

FIG. 15A is a back, top and right perspective view of a follow focus coupled with a mounting apparatus and engaging a camera lens.

FIG. 15B is a top view of the follow focus coupled with a mounting apparatus and engaging a camera lens.

FIG. 16 is a right side view of a follow focus with a release button line and stop lines on the knob.

### DRAWING NUMERALS

10 front side
11 back side
12 knob ring
13 sidewall
14 knob
15 left release button
16 right release button
17 clip
18 bumper line
20 focus wheel
110 lock ring
114 ring track
130 right release button aperture
131 left release button aperture
132 hard stop line
134 soft stop line
136 free spin line
138 release button line
140 right guide
141 left guide
142 hard stop groove
144 soft stop groove
146 free spin groove
148 knob detent
150 pin
152 spring
162 first hard stop lock
164 second hard stop lock
170 inner ring
172 outer ring
174 wheel lock
200 focus gear
202 knob gear
203 wheel bridge
204 axis screw
210 wheel housing
240 tooth 240
250 bumper
252 first inner stop
254 second inner stop
300 hard stop orientation
302 soft stop orientation
304 free spin orientation
400 focus axis
402 rotation axis
500 focus range
600 camera lens
602 focus ring
700 mounting apparatus

### DETAILED DESCRIPTION OF THE DRAWINGS

A focus wheel 20 extends from a wheel housing 210. The focus wheel 20 may couple with a focus gear 200. A surface of the focus gear 200 may be knurled or comprised of ridges. A knob gear 202 may extend perpendicular to the focus gear 200. A surface of the knob gear 202 may comprise oblique grooves. The grooves of the knob gear 202 and focus gear 200 may engage, whereby rotation of the wheel 20 causes rotation of the knob gear 202. Together, the focus gear 200 and knob gear 202 may jointing form a worm gear capable of transferring torque on a knob 14 to the focus wheel 20. The wheel housing 210 may house both the focus gear 200 and knob gear 202.

A knob gear 202 extends towards the knob 14 and couples with wheel lock 174 housed in the knob 14. The wheel lock 174 couples with a lock ring 110 aspect of the knob 14. An axis screw 204 extends from the knob gear 202 and couples with an aspect of the knob 14. Rotation of the knob 14 around a knob axis 402 causes rotation of the focus wheel 20 around a focus axis 400. The rotation may be proportionate. For example, rotating the knob 90 degrees around the knob axis 402 may cause the focus wheel 20 to rotate 90 degrees around the focus axis 400.

A knob ring 12 may circumferentially extend around the outer surface of the knob 14. The knob ring may be comprised of thermoplastic elastomer or other substance that enhances the ability to manually grip the knob 14. Release buttons (16, 15) may extend through release button apertures (130, 131) in the knob 14 and knob ring 12. Within the knob 14, each release button (16, 15) may couple with a guide (140, 141). The guides (140, 141) may be arcuate to contour the inner surface of a sidewall 13 of the knob 14. The release buttons (16, 15) may partially house a pin 150. The pin 150 may be disposed between the proximate ends of the release buttons (16, 15). The pin 150 may operatively couple the release buttons (16, 15) and cause them to move together. A biasing device, such as a spring 152, may be disposed between the release buttons (16, 15). A spring 152 may sleeve the pin 150. The spring 152 may urge the release buttons (16, 15) outward, into a locked orientation wherein the guides (140, 141) may abut and otherwise engage inner surface of the knob 14 sidewall 13. In a locked orientation an outer surface of the guides (140, 141) may lay flush with the inner surface of the knob 14 sidewall 13.

An outer ring 172 and inner ring 170 may comprise the back side 11 of the knob 14. A first stop lock 162 may be integrally connected with the inner ring 160 and be capable of rotation around a rotation axis 402 with the inner ring 160. A second stop lock 164 may be integrally connected with the outer ring 170 and be capable of rotation around the rotation axis 402 with it. The release buttons (16, 15) may couple with the lock ring 110. A bumper 250 may extend from the lock ring 110. Inner stops (252, 254) may penetrate the hub 14 and, in some orientations interface with the lock ring 110.

A screw component of the hard stop lock (162, 164) may be turned until the screw abuts a surface wheel housing 210, is inserted into the wheel housing 210, or otherwise engages the wheel housing so that the hard stop lock (162, 164) creates a “hard stop,” i.e. is held stationary and will not rotate when the knob is rotated 14. “Hard stop” herein refers to a resistance to rotation in one direction which is not intended to be overcome by manual rotation force on the knob 14. When the hard stop locks (162, 164) are not configured in a hard stop, they, along with the rings (170, 172) may rotate in conjunction with the knob 14. When a hard stop lock (162, 164) is engaged to create a hard stop, it is held stationary against rotation of the knob 14.

Three grooves (142, 144, 146) may be cut into the inner surface of the knob 14. The groove closest to the back side 11 may comprise a hard stop groove 142. The middle groove may form a soft stop groove 144. The furthest groove may form a free spin groove 146. Two sets of grooves (142, 144, 146) may be disposed in positions allowing them to interact on the inner surface of the sidewall 13.

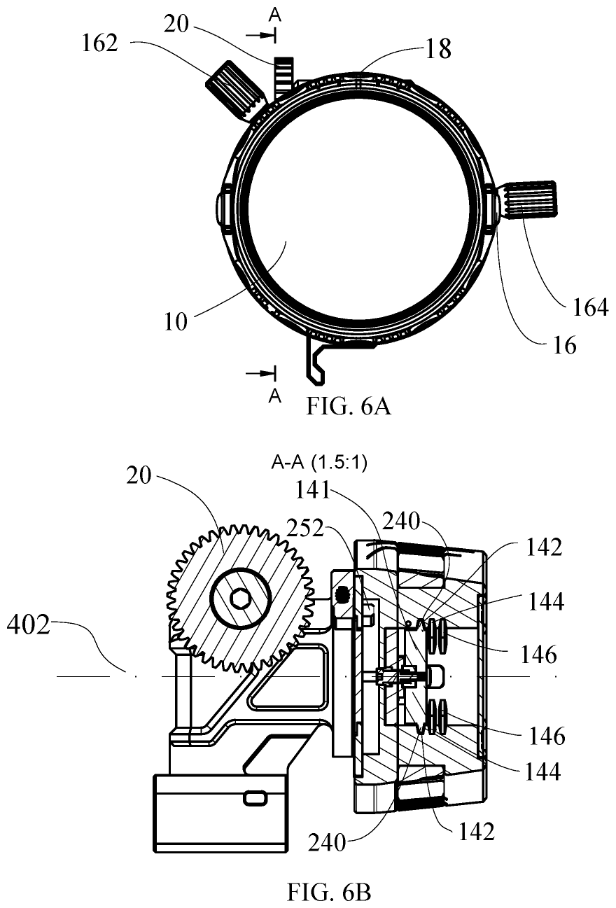

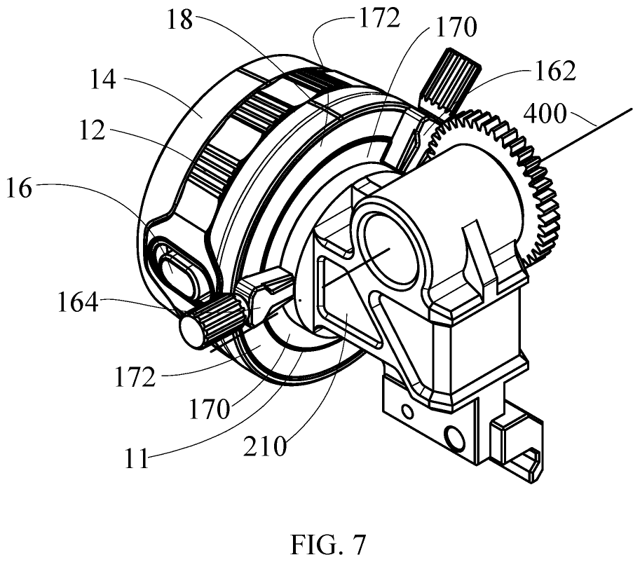

Each guide (140, 141) may comprise a guide tooth 240 configured to engage the grooves (142, 144, 146) when the (142, 144, 146) when the release buttons (16, 15) are urged into their default locked position (see FIG. 6B). The release button apertures (130, 131) may be configured to enable the release buttons to move laterally into a plurality of stop orientations. Each stop orientation may correspond to the guide (140, 141) being engaged with one of the grooves (142, 144, 146).

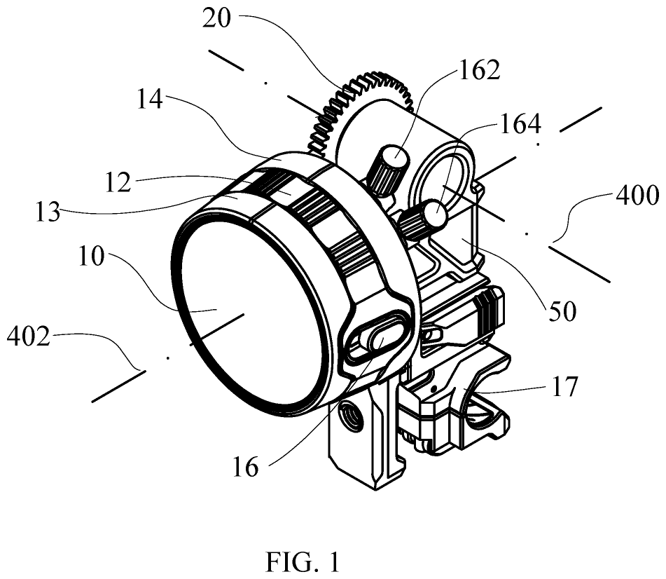

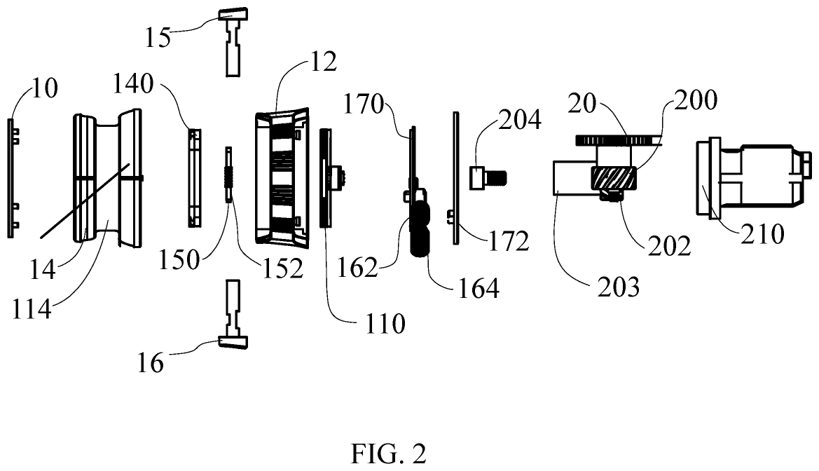

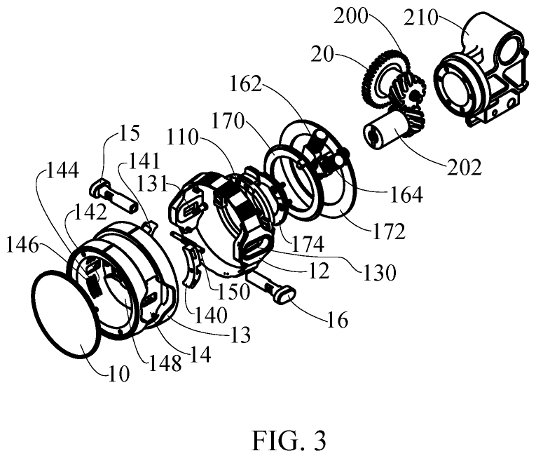

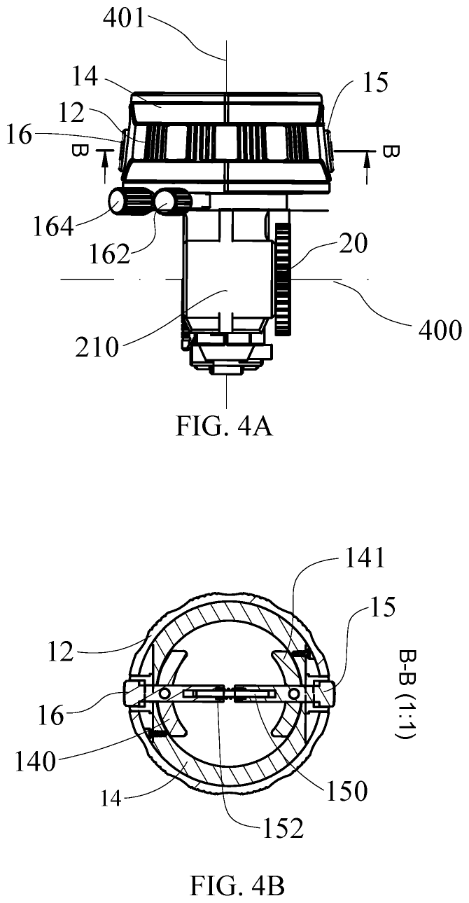

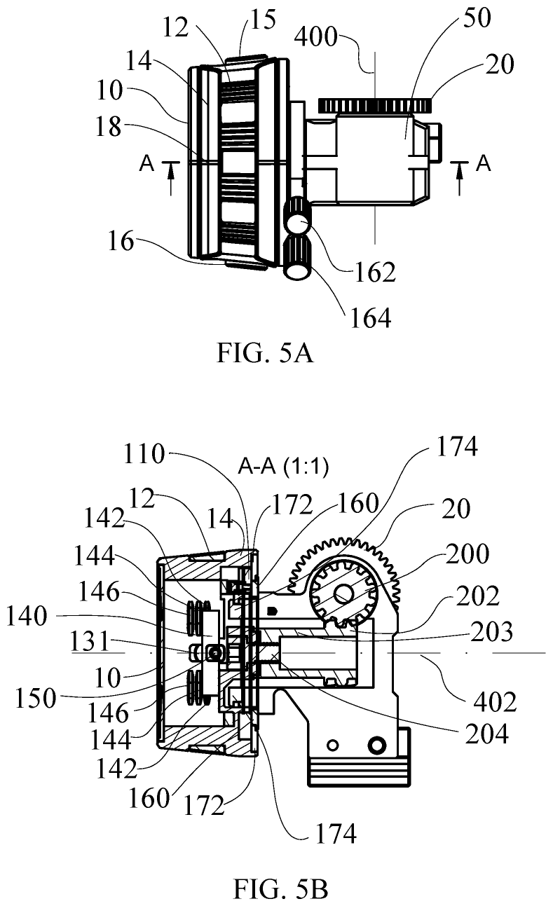

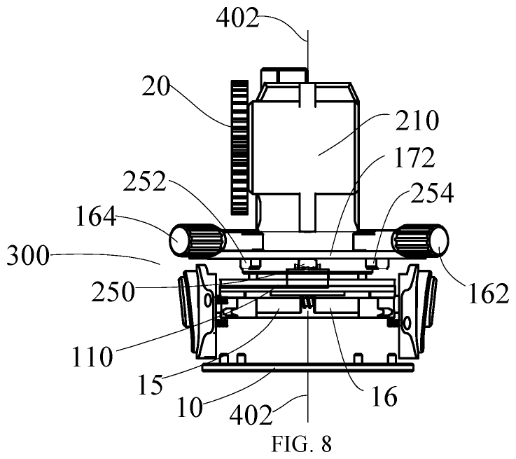

For example, a hard stop orientation 300 may be created when the release buttons (16, 15) are oriented to the back (see FIGS. 1 and 8) of the release button apertures (130, 131). The guide teeth 240 engage the hard stop groove 142, thereby locking the guides 140 in place. The lock ring 110 is oriented towards the outer ring 172 to engage the stop locks (162, 164). The bumper 250 extends towards the back side. When rotated in the hard stop orientation 300, the bumper 250 will abut and not be able to move past the inner stops (252, 254). If the hard stop lock (162, 164) inner stop is in a hard stop, the bumper 250 will not be able to move past the inner stop (252, 254), and contact of the bumper 250 and inner stop (252, 254) will prevent rotation of the knob 14.

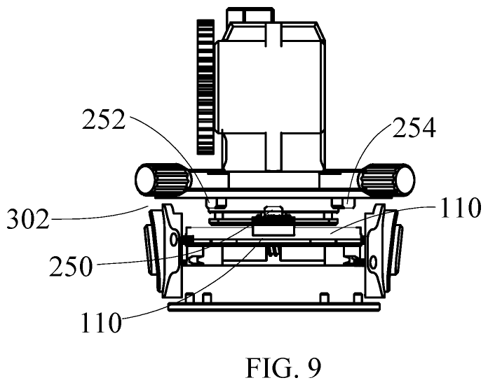

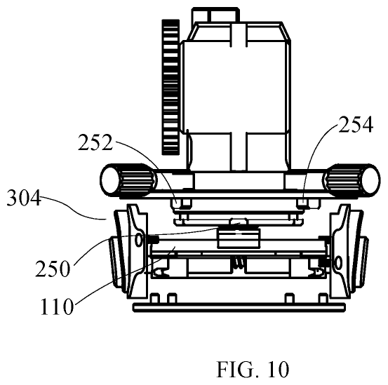

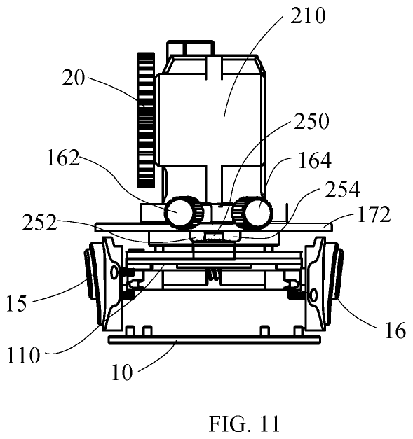

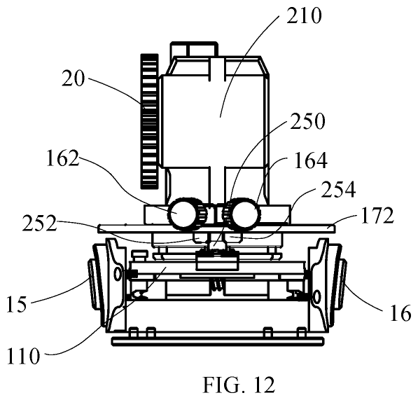

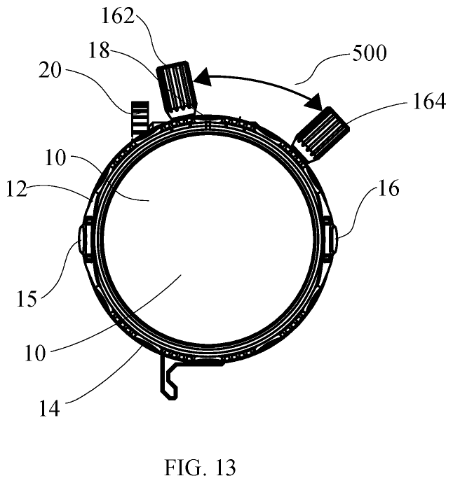

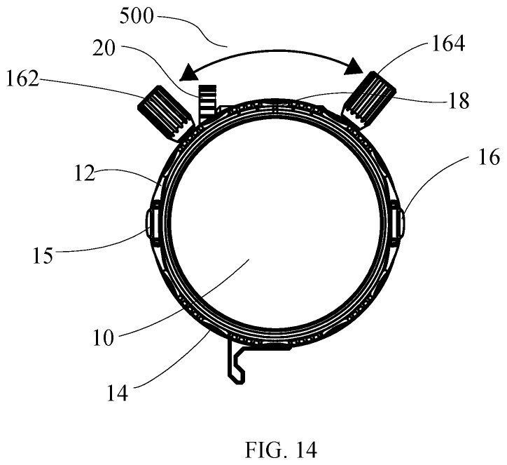

A soft stop orientation 302 may be created by orienting the release buttons (16, 15) laterally to be oriented in the relative middle of the release button apertures (see FIG. 9). In a soft stop orientation 302 the guide teeth 240 engage the soft stop groove 144, thereby locking the guides 140 in place. The lock ring 110 shifts laterally towards the front side 10, away from the stop locks (162, 164). The lock ring 110 and the stop locks (162, 164) are still oriented to engage and create soft stops. “Soft stop” herein means engagement creating resistance to rotation that is intended to be overcome by a predetermined amount of manual force exerted on a ring (160, 170). When the inner lock (252, 254) is in a hard stop, the inner lock remains stationary, but the knob may still be rotated past it. The soft stop may provide haptic feedback to the operator, enabling to feel when the knob is rotated to the soft stop.

The bumper 250 and inner stops (252, 254) may be chamfered to enable the soft stop contact. The bumper 250 and inner stops (252, 254) may be made of metal, plastic, Delrin® acetal plastic, or other thermoplastic. The relatively low friction and high stiffness offered by thermoplastic like Delrin® may be beneficial in allowing the inner stops (252, 254) and bumper (250) to enabling both hard stop and soft stop contact. The knob 14 and wheel housing 210 may be comprised of plastic, aluminum, or another metal. In the soft stop orientation 302, only the chamfered surfaces of the side of the bumper 250 and inner stops (252, 254) may interface.

A free spin 304 orientation may be created by orienting the release buttons (16, 15) laterally towards the front side 10. The guide teeth 240 may engage the free spin groove 146, thereby locking the guides (140, 141) in place. The lock ring 110 moves laterally forward, away from the stop locks (162, 164). The lock ring 110 and stop locks (162, 164) do not engage and the knob is free to rotate around the focus axis 100.

The spring 152 urges the release buttons outward towards the locked position, whereby the guide (140, 141) teeth 240 are urged into and engage with the aligned the groove (142, 144, 146). The release buttons (16, 15) may be moved between the orientations (300, 302, 304) by pressing them inward to overcome the biasing force of the spring 152. The release buttons (16, 15) are compressed inward towards the knob axis 402, and the release buttons (16, 15) may be moved laterally.

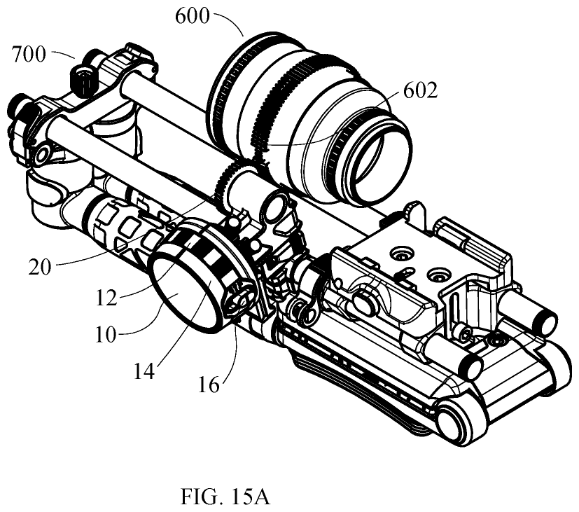

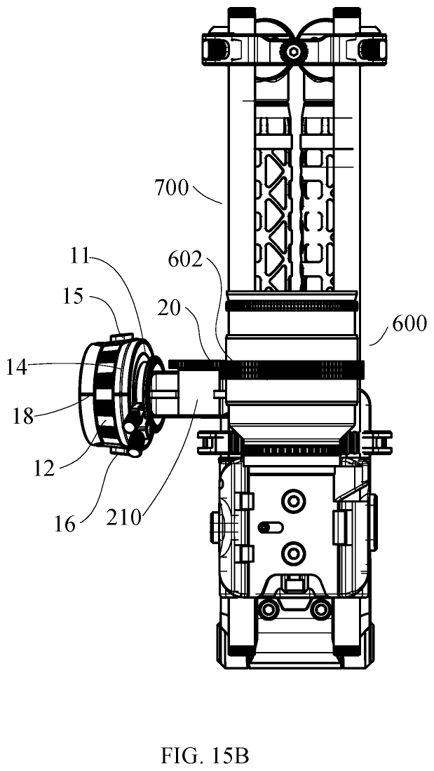

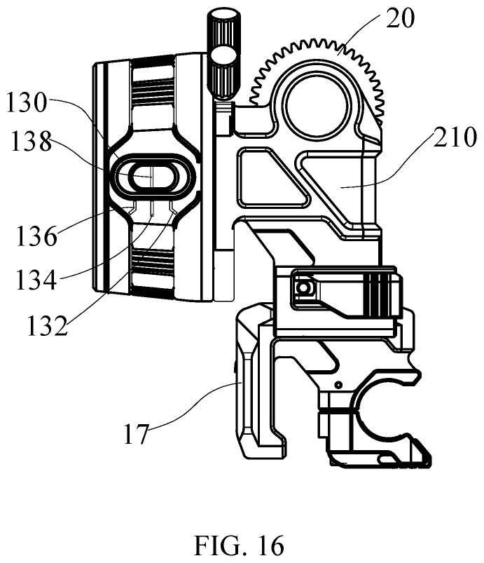

The focus wheel 20 is configured to engage a camera lens or another aspect of a camera or camera accessory. FIGS. 15A and 15B show the follow focus mounted on an exemplary mounting apparatus 700 and engaging an exemplary camera lens 600. The clip 17 may be used to couple the follow focus with the mounting apparatus 700. The clip 17 may enable adjustment of the coupled follow focus relative to the lens 600.

The lens 600 may be mounted to a camera (not shown) or directly to the mounting apparatus 700. A focus ring 602 may surround the annular surface of the lens 600. The focus ring 602 may comprise grooves or ridges capable of engaging with focus wheel 20 ridges.

The follow focus is positioned so the focus wheel 20 ridges engage the focus ring 602. The wheel 14 is rotated by the operator. Rotation of the wheel 14 causes the focus wheel to rotate, thereby engaging and rotating the focus ring 602.

A operator may use look through the lens 602 or use the viewfinder of a coupled camera to determine the ideal focus range 500. “Focus range” may be used herein to mean the distance the bumper 250 is capable of continuously rotating without hitting either inner stop (252, 254) when the knob 14 is in a hard stop orientation 300 or soft stop orientation. The hard stop locks (162, 164) are set to create the corresponding stop range 500. The exemplary hard stop locks (162, 164) may sleeve their respective ring (170, 172).

The release buttons (16, 15) are moved to the hard stop orientation 300 if the operator wants rotation of the focus ring 602 to be limited to the focus range 500. The release buttons (16, 15) may be moved to the soft stop orientation 302 if the operator desires the ability to rotate the focus ring 602 through a greater range of motion than the focus range 500. In the soft stop orientation 302 302, the bumper 250 will contact either the first inner 252 or second inner 254 stop, providing haptic feedback to an operator turning the knob 14. In the soft stop orientation 302 302, the stop range 500 serves as a reference point for the operator, while enabling free rotation of the focus ring 602.

Adjustment of the release buttons (16, 15) to the free spin orientation 304 304 enables free rotation of the wheel and

A bumper line 19 may be on the outer, exposed surface of the knob 14. The bumper line 19 may indicate the location of the unexposed bumper 250.

A release button line 138 may be drawn on each release button (16, 15). A hard stop 132, soft stop line 134, and free spin line 136 may be drawn on the knob 14. Alignment of the release button 138 and the stop lines (132, 134, 136) may indicate when the follow focus is in each stop orientation (300, 302, 304).

The foregoing disclosure is for illustration and description. Alternative embodiments may be possible in light of the above teachings. The embodiments described where chosen to explain the principles of the invention and its practical application to enable others skilled in the art to best utilize the invention. It is intended that any claims thereafter be construed to include other alternative embodiments of the invention except as limited by the prior art.

I claim:

1. A follow focus, comprising:
a. an focus wheel;
b. a focus gear extending from the focus wheel;
c. a lock ring housed in and coupling with a knob;
d. a knob gear extending from the lock ring, the knob gear and focus gear configured to engage each other and transfer rotational energy between each other;
e. the knob comprising an inner ring and an outer ring;
f. each outer ring comprising a hard stop lock;
g. each hard stop lock comprising an inner stop, the inner stops comprising a focus range;
h. the lock ring comprising a bumper, the bumper extending towards the inner ring and outer ring;
i. each hard stop lock capable of being activated to create a hard stop, wherein the inner stop remains stationary when the knob is rotated;
j. a guide, the guide extending from the lock ring, the guide comprising a tooth extending towards a sidewall of the knob;
k. three grooves on the inner surface of the sidewall of the knob, the three grooves comprising a hard stop groove, soft stop groove, and a free spin groove;
l. a release button, the release button coupling with the lock ring, and coupling with the guide;
m. the release button extending from a release button aperture, whereat the release button may be manually manipulated;
n. a biasing device, the biasing device urging the release button outward towards the sidewall of the knob, whereby the guide is urged outward and the tooth can engage one of the three grooves, if so aligned;
o. the release button capable positioned in a hard stop position, whereby the tooth engages the hard stop groove, and the bumper may be disposed between the inner stops within the focus range, and the inner stop prevent the bumper from rotating out of the focus range when both hard stop locks are activated to create a hard stop;
p. the release button capable being positioned in a soft stop orientation, whereby the tooth engages the soft stop groove, and the bumper contacts one of the inner stops when rotated into or out of the focus range;
q. the release button capable of being positioned in a free spin orientation, whereby the tooth engages the free spin groove, and the bumper does not contact the inner stops when moving into or out of the focus range;
r. the lock ring coupling with the release button and moving in association with it, whereby the lock ring is moved into the hard stop orientation, soft stop orientation, and free spin orientation.

2. A follow focus, comprising:
a. a hub, the hub having a back side, a front side, and a sidewall;
b. the sidewall comprising two release button apertures;
c. two release buttons, each release button extending through one release button aperture and towards a rotation axis;
d. the release button apertures being configured to enable movement of the release buttons relative to the back side;
e. a biasing device disposed between the two release buttons, the pin spring urging each release button outward towards the sidewall, and into an engaged position;
f. the sidewall comprising two sets of three grooves;
g. two guides, each guide coupled with one of the two release buttons;
h. each guide comprising a tooth;
i. in a specific orientation, each tooth being configured to engage each of the three grooves in one of the two sets of three grooves in a specific orientation;
j. a lock ring, the lock ring coupling with the two release buttons, the lock ring moving in conjunction with the two release buttons;
k. the lock ring being coupled with the knob, whereby the lock ring rotates in conjunction with the knob;
l. the back side comprising two adjustable inner stops, the two stops comprising the limits of a focus range;
m. the lock ring comprising a bumper, the bumper extending towards the back side;
n. in certain orientations, each inner stop being capable of contacting the bumper when the bumper is rotated around the rotation axis of;
o. the knob coupling with a knob gear;
p. a focus wheel, the focus wheel configured to engage and rotate a camera lens;
q. a focus gear, the focus gear extending from the camera, the focus gear being configured to engage with the knob gear, whereby rotation of the knob results in rotation of the focus wheel.

3. The follow focus in claim 2, wherein:
a. a hard stop groove, a soft stop groove, and a free spin groove comprise the three grooves in each of the two sets of three grooves;
b. the follow focus being so configured that when the teeth are engaged with the hard stop grooves, the bumper is incapable of rotating past either inner stop, whereby a hard stop position is formed.

4. The follow focus in claim 3, wherein the follow focus is so configured that when the teeth are engaged with the soft stop grooves, the bumper can contact each inner stop when rotated past it, such engagement causing haptic feedback, whereby a soft stop position is formed.

5. A follow focus, comprising:
a. a knob coupled with a focus wheel;
b. the knob comprising a bumper and two inner stops, the two inner stops comprising a focus range;
c. the knob comprising a two release buttons, the release button as a means of moving the bumper;
d. the release buttons being configured to move into a plurality of orientations relative to the two inner stops;
e. each inner stop preventing the rotation of the bumper out of the focus range when the release button is in a hard stop orientation;
f. each inner stop engaging the bumper and providing haptic feedback when the bumper is rotated past the respective stop when the release button is in a soft stop orientation;
g. each inner stop not contacting the bumper when the knob is rotated with the release button in a free spin orientation.
